(19) United States
(12) Patent Application Publication
(10) Pub. No.: US 2001/0027735 A1
(43) Pub. Date: Oct. 11, 2001

(54) Methods of producing a water-repellent product, and product and method for waterproofing a surface of a building material

(76) Inventor: Joseph E. Doumet, Paris (FR)

Correspondence Address: Reising, Ethington, Barnes, Kisselle,, Learman & McCulloch, P.C., 5291 Colony Drive North, Saginaw, MI, 48603, US

(21) Appl. No.: 09/788,914

(22) Filed: Feb. 19, 2001

Related U.S. Application Data
(63) Continuation-in-part of application No. 09/284,761, filed on Apr. 4, 2000.

(30) Foreign Application Priority Data
Aug. 6, 1998 (EP) PCT/EP98/04914
Dec. 15, 1997 (EP) 97 122 083.5

(51) Int. Cl. B05D 3/02; C09K 3/18

(52) U.S. Cl. 106/613; 427/397.8; 427/376.2; 106/2

(57) ABSTRACT

A surface of solid building material may be waterproofed and impregnated against chemical and biological corrosion by forming first and second aqueous solutions one of which contains calcium ions and the other of which contains sodium and silica ions. The two solutions may be mixed and applied simultaneously to the surface or the two solutions may be applied to the surface sequentially, the solution containing the sodium and silica ions being applied first. In either case there is formed on the building material surface a hard, glass-like transparent coating of sodium calcium silicate.

### RELATED APPLICATION

This application is a continuation-in-part of application Ser. No. 09/284,761 filed Aug. 6, 1998.

This invention relates to a water-repellent product, methods of producing such water-repellent product, and to methods of treating and impregnating a surface of solid building materials against liquids as well as against chemical and biological corrosion.

### BACKGROUND OF THE INVENTION

There are on the market numerous products or agents which are intended for painting or coating surfaces of solid building materials, such as walls, ceilings and/or floors of parts of buildings, water tanks, swimming pools, or the like in order to waterproof these surfaces and/or to impregnate them against chemical and biological corrosion. These known products may generally be rubber-based or plastic-based products (synthetic resin or epoxy resin) or also special paints. However, these known products which are available on the market have shown themselves to be frequently inadequate in their effect and in their durability, particularly when several requirements are to be met simultaneously, as is the case for example when surfaces are to be protected against liquids (particularly water) and also simultaneously against chemical and/or biological corrosion, such as occurs for example in water reservoirs, swimming pools and the like which are built in the open.

The object of the invention, therefore, is to provide an appropriate water-repellent product, methods of producing such product, and methods of treating surfaces of building materials with such product in such a way that, on the one hand, a treatment product or coating product is made available which is relatively simple and economical to produce as well as having many uses and being reliable and durable in its effect and, on the other hand, such a product can be applied relatively simply and quickly to a surface of a building material which is to be protected.

### SUMMARY OF THE INVENTION

A first aspect of the present invention concerns a method of producing or preparing a treatment product or coating product in order to make a surface of building materials water-repellent or waterproof and thereby to impregnate or protect such surface against liquids as well as against chemical and biological corrosion. According to the invention such a product is generally produced by the following steps:

a) preparing a first aqueous solution (base solution) by dissolving calcium oxide (CaO) in a quantity of water with the aid of a dissolving agent which is admixed with this quantity of water in order to increase the dissolution or the dissolving effect of the calcium oxide in water;

b) preparing a second aqueous solution which contains water and a sodium silicate and, in one embodiment of the invention;

c) mixing together the first aqueous solution and the second aqueous solution so that an aqueous solution product (treatment product or coating product) is formed which contains silica, calcium, and sodium ions and which forms a glass-like surface film on the corresponding building material surface.

In another embodiment of the invention the first and second solutions are prepared in the manner described above, but rather than being mixed together are applied to the building material surface sequentially commencing with the second solution.

By means of these methods of production according to the invention a product is made available which is ready for use in the form of an aqueous solution and which can be applied in a manner which is extremely simple to handle and relatively quickly to a building material surface which is to be protected. However, in the dried state the product produces a solid and durable, insoluble surface film due to the double silicate (sodium calcium silicate) which is formed because of the silica, calcium, and sodium ions present in the prepared aqueous solvent product.

In the methods of producing the product particular importance is given to the knowledge that calcium oxide dissolves in water only in extremely small quantities. In order to be able to dissolve a sufficient quantity of calcium oxide in the given quantity of water, first of all according to the invention the first aqueous solution (referred to above under a) is prepared, in which a sufficiently large quantity of calcium oxide can be dissolved in the predetermined quantity of water because this quantity of water has a suitable dissolving agent mixed with it in order thereby to improve or to increase the dissolution of the calcium oxide. In this connection it should be mentioned that only approximately 1 g of calcium oxide can be dissolved in one liter of water; however, by the admixture of the dissolving agent a multiple of this quantity of calcium oxide can be dissolved in the same quantity of water, so that this admixture of the dissolving agent makes it possible to dissolve a correspondingly larger quantity of calcium oxide in the same quantity of water and thereby to control the ratio of calcium oxide and sodium silicate in the prepared aqueous solution product.

Basically any dissolving agent which is suitable for dissolving an increased quantity of calcium oxide in the given quantity of water can be used in the quantity of water of the first aqueous solution. According to the present invention it is particularly preferred if sugar in the form of saccharose (C₁₂H₂₂O₁₁) is used as the dissolving agent in the first aqueous solution in order to dissolve an increased quantity of calcium oxide therein. Thus ordinary sugar can be used to a certain extent as a type of catalyst in order markedly to increase the dissolving power of the calcium oxide in water. Thus for example approximately 24 g of calcium oxide (CaO) can be dissolved in a liter of water to form 32 g of -calcium hydroxide [Ca(OH₂)] in which 400 g of sugar/saccharose is dissolved, which means that 100 g of sugar/saccharose contribute to approximately 8 g of calcium hydroxide being dissolved in a corresponding quantity of water.

In many cases, however, it may also be favourable in the method of production according to the invention to use glycerine (CH₂OH—CHOH—CH₂OH) as the dissolving agent in the first aqueous solution in order to increase the dissolution of the calcium oxide therein. With this use of glycerine, however, it should be noted that, while an increased quantity of calcium oxide can indeed be dissolved in the water, the capacity for dissolving calcium oxide in the water is less than that when saccharose is used. In any case, however, by the admixture of glycerine to the first aqueous solution a quantity of calcium oxide (CaO) of approximately 3% by weight of the glycerine can be dissolved, which can be sufficient for many uses of the finished product.

### DETAILED DESCRIPTION

When the first aqueous solution is being prepared the procedure advantageously is such that first of all a quantity of demineralised water is boiled in order to degasify it. Then the dissolving agent is added to this quantity of water and thereupon the calcium oxide in the form of quicklime or calcium hydrate (in the quantity required in the particular case) is admixed with the water at room temperature and thereby dissolved, so that the first aqueous solution is formed. By this degasification all carbonic acid gas is removed from the water, since otherwise carbonic acid gas would precipitate calcium oxide as calcium carbonate (CaCO₃). Only after degasification is the dissolving agent (saccharose or glycerine) added to the quantity of water. Although this addition of the dissolving agent basically can take place in warm water, it is preferable for the water first of all to be cooled to room temperature (approximately 20 to 25° C.) after the degasification and only thereafter for the dissolving agent to be added. The coordinated quantity of calcium oxide, likewise at room or ambient temperature, is then admixed with the water so that it can be dissolved therein.

For the production according to the invention of the treatment product or coating product, calcium oxide is advantageously added in the form of quicklime (CaO) in a ratio which depends upon the quantity of dissolving agent used, calcium hydrate [Ca(OH₂)] being formed in the first aqueous solution. However, as mentioned above, calcium hydrate [Ca(OH₂)] can be directly added instead of quicklime.

According to the invention it is also advantageous that calcium oxide and sodium silicate are added to (dissolved in) the first and second aqueous solutions in such quantities or proportions that the finished aqueous solution product, that is to say the treatment product or coating product, contains a ratio of calcium to sodium, i.e., Ca:Na₂ of approximately 0.1 to 1.0. The flexibility or the strength of the dried and possibly hardened finished product film on the building material surface to be protected can be controlled in the desired manner by means of this ratio of Ca:Na₂. In fact, the greater the ratio Ca:Na₂ is, the harder and less flexible the dried product film on the coated surface becomes; however, if this ratio in the finished product is too low, then the latter becomes more easily soluble in water, whilst too high a proportion of calcium (Ca) gives the finished product film a tendency to fracture or burst.

Amongst the various possible types of sodium silicate used here, in the tests on which the invention is based, sodium metasilicate pentahydrate (Na₂ * SiO₃ * 5H₂O) which, in the dissolved state can be used in the second aqueous solution, has proved favourable, as have other sodium silicates all of which are soluble in water. For example, a silicate containing 7.5 to 8.5% Na₂O and 25.5 to 28.5% SiO₂, readily available in the market, can be used. However, other formulas of water-soluble sodium silicate may and can be used to adjust also the preferred ratio of SiO₂ to Ca+Na₂.

The present invention is—according to a second aspect—also directed to a product or agent for water-repellent/waterproof treatment and for impregnation of a porous surface of building materials against liquids (particularly water and the like) as well as against chemical and biological corrosion. According to the invention this product is distinguished by an aqueous solution product which contains silicon, calcium, and sodium ions, wherein calcium oxide is dissolved in water, an appropriate dissolving agent having been added to this water, and wherein this aqueous solution product, after it has been applied to the surface of the building material and dried there, forms a hard glass-like surface film. This product is preferably one which has been produced according to the methods described above. This aqueous solution product therefore advantageously contains calcium and sodium in a ratio of Ca:Na₂ of approximately 0.1 to 1.0.

The dissolving agent used in the finished product (for increased dissolution of a sufficient quantity of calcium oxide in the water) may be of various types. Particularly preferred is sugar in the form of saccharose, which is previously dissolved in the first aqueous solution as an agent for dissolving the calcium oxide or the calcium hydroxide. Sugar or saccharose is capable of dissolving a particularly large quantity of calcium oxide in the form of calcium hydroxide in the water, as has already been explained above. Glycerine, which in many cases can likewise be admixed as a dissolving agent with the initial quantity of water of a first aqueous solution has by comparison a somewhat reduced capacity for dissolving calcium oxide in water.

It should also be mentioned at this point that other suitable dissolving agents are also usable for increased dissolution of the calcium oxide in the water, even if they do not generally achieve the particularly favourable and high dissolving effect of sugar or saccharose. Phenol, an organic chemical product, may be mentioned for example as another dissolving agent to be used instead of the organic dissolving agent saccharose.

If sugar or saccharose is used as the dissolving agent in the aqueous solution product according to the invention, then the finished product thus produced contains the following components in % by weight:

| | |
|---|---|
| 52.5 to 56% | water (H₂O) |
| 24 to 33% | saccharose (C₁₂H₂₂O₁₁) |
| 1.9 to 2.7% | calcium oxide (CaO) |
| 8.6 to 21.3% | sodium metasilicate pentahydrate |
| | (Na₂ * SiO₃ * 5H₂O) |

If, by contrast, gylcerine is used as dissolving agent in the aqueous solution product, then this product contains the following components in % by weight:

| | |
|---|---|
| 55.6 to 68% | water (H₂O) |
| 31 to 36.6% | glycerine (C₂OH—CHOH—CH₂OH) |
| 1.1 to 1.31% | calcium oxide (CaO) |
| 4.3 to 12.3% | sodium metasilicate pentahydrate |
| | (Na₂ * SiO₃ * 5H₂O). |

Some examples of different compositions in the product according to the invention are set out below, on the one hand in the case where sugar/saccharose is used as the dissolving agent and on the other hand in the case where glycerine is used as the dissolving agent, and moreover these examples of compositions differ in the different ratios of Ca:Na₂ in the particular compositions. (It will be understood that if another sodium silicate is used, the specified percentages will vary according to the formula of the sodium silicate used.)

### EXAMPLE 1

With a ratio Ca:Na₂ of 0.3, individual components being listed in % by weight:

| | |
|---|---|
| 52.5% | water (H₂O) |
| 24.27% | saccharose (C₁₂H₂₇O₁₁) |
| 1.93% | calcium oxide (CaO) |
| 21.3% | sodium metasilicate pentahydrate |
| | (Na₂ * SiO₃ * 5H₂O) |
| 100% | |

### EXAMPLE 2

Use of saccharose as the dissolving agent, with a ratio Ca:Na₂ of 0.5:

| | |
|---|---|
| 54.12% | water (H₂O) |
| 28.56% | saccharose (C₁₂H₂₂O₁₁) |
| 2.28% | calcium oxide (CaO) |
| 15.04% | sodium metasilicate pentahydrate |
| | (Na₂ * Si₃ * 5H₂O) |
| 100% | |

### EXAMPLE 3

Use of saccharose as the dissolving agent, with a ratio Ca:Na₂ of 1:

| | |
|---|---|
| 55.78% | water (H₂O) |
| 32.92% | saccharose (C₁₂H₂₂O₁₁) |
| 2.63% | calcium oxide (CaO) |
| 8.67% | sodium metasilicate pentahydrate |
| | (Na₂ * SiO₃ * 5H₂O) |
| 100% | |

### EXAMPLE 4

Use of glycerine as the dissolving agent, with a ratio Ca:Na₂ of 0.3:

| | |
|---|---|
| 55.63% | water (H₂O) |
| 31.00% | saccharose (CH₂OH—CHOH—CH₂OH) |
| 1.11% | calcium oxide (CaO) |
| 12.26% | sodium metasilicate pentahydrate |
| | (Na₂ * SiO₃ * 5H₂O) |
| 100% | |

### EXAMPLE 5

Use of glycerine as the dissolving agent, with a ratio Ca:Na₂ of 0.5:

| | |
|---|---|
| 56.8% | water (H₂O) |
| 33.94% | saccharose (CH₂OH—CHOH—CH₂OH) |
| 1.22% | calcium oxide (CaO) |
| 8.04% | sodium metasilicate pentahydrate |
| | (Na₂ * SiO₃ * 5H₂O) |
| 100% | |

### EXAMPLE 6

Use of glycerine as the dissolving agent, with a ratio Ca:Na₂ of 1:

| | |
|---|---|
| 57.83% | water (H₂O) |
| 36.53% | saccharose (CH₂OH—CHOH—CH₂OH) |
| 1.31% | calcium oxide (CaO) |
| 4.33% | sodium metasilicate pentahydrate |
| | (Na₂ * SiO₃ * 5H₂O) |
| 100% | |

Generally, all these compositions forming the aqueous solution product can be diluted by water if needed or helpful for use.

According to a third aspect the present invention also relates to methods of waterproofing and impregnating a building material surface in order to protect it against liquids, particularly water and the like, as well as against chemical and biological corrosion, by the application of a coating product in its liquid or paintable state onto the surface which is to be protected. According to one embodiment of the invention this takes place by the following steps:

a) preparing a first aqueous solution by dissolving a quantity of calcium oxide in a first quantity of degasified (or demineralised) water with the aid of a dissolving agent which is admixed with this quantity of water in order to increase the dissolution (dissolving capacity) of the calcium oxide;

b) mixing together the first aqueous solution with a second aqueous solution containing sodium silicate in a second quantity of water in order to form an aqueous solution product (as coating product) which contains silicon, calcium and sodium ions:

c) applying the aqueous solution product to the porous surface of the building material on which it dries and hardens to a glass-like surface film.

The application of the aqueous solution product to the building material surface should be done promptly after the mixing of the first and second solutions together and in any case before the double silicate forms and precipitates.

In this case the product produced by the method according to the invention as described can in particular be used as a coating product. The aqueous solution product thus produced can be applied extremely simply and quickly to a building material surface which is to be protected. The product which is applied to this surface and dried and hardened to a glass-like surface film constitutes a coating product which has very many uses and acts extremely reliably and durably and which—because of the production described above and the components used therein—can also be produced very simply and economically.

In the practical application of the coating product thus produced it may be advantageous to apply successive coats of thin layers to the surface of the building material to be protected in order to waterproof and impregnate such surface. This application can be carried out in particular by rolling (with paint rollers), brushing or spraying. The coats applied to a building material surface can be dried and hardened by the use of warm air and/or by natural evaporation (due to the influence of ambient air). After drying and hardening any parts of the dissolving agent that may have precipitated on the surface of the coating can be washed off in a simple manner, for example with the aid of water, but optionally also these parts which are precipitated can simply be washed off naturally by rain. In the case where saccharose is the dissolving agent, precipitation will be in the form of a crystallisation of saccharose at the surface that has been waterproofed.

In the case of the application of the first and second aqueous solutions (a) and (b) separately, the second solution (b) is applied in several successive coats, each coat being dried before the next coat is applied. Following the application and drying of the last coat of solution (b), several successive coats of solution a may be applied over the coats of solution (b), each coat of solution (a) being dried before the next coat is applied. Preferably the number of coats of solutions (a) and (b) are the same, thereby enabling the selected ratio of Ca:Na₂ to remain constant.

Solution (b) is transparent and will be absorbed by the pores of the surface to be protected. When solution (a) is applied over solution (b) and dried, a glass-like surface film is formed by a double silicate (calcium sodium silicate) that is not soluble in water. Should there be any efflorescence of the saccharose after drying of the final coating, it can be washed either manually or naturally by rain.

The methods according to the invention can be used in particular for waterproofing and impregnation of porous surfaces on solid building material, particularly concrete, concrete-like, or cement-like materials, stone materials, wood and the like.

In the tests on which the invention is based the walls of an old swimming pool were waterproofed and impregnated with the coating product produced according to the invention using either of the methods of application described above.

In this old swimming pool the exposed faces consisted of a mosaic of ceramic parts in small pieces, between which there were cement joints. Moss had grown increasingly on the faces or surfaces of these swimming pool walls, apart from the fact that such faces had in part become permeable to water.

First of all it was attempted on the one hand using previously known materials to waterproof a section of the cleaned faces (wall surfaces) and on the other hand to impregnate them in particular against the growth of moss using a large number of various products available on the market (which had a rubber or synthetic resin base or were special paints). None of these known products could permanently eliminate the growth of moss and at the same time create sufficient impermeability to water. The use of some of these known products even led to unwanted colour changes in the mosaic walls of the swimming pool, which brought new problems with it.

Other sections of the exposed faces (surfaces) of these swimming pool walls were thereupon coated by the methods according to the invention with the product produced according to the invention. Accordingly the aqueous solution product (i.e., the mixture of the first and second aqueous solutions) was applied shortly after mixing to the exposed faces of the walls and of the base of the swimming pool with the aid of a paint roller in a plurality of thin coats, namely five coats, sufficient time being allowed between applications to facilitate thorough drying out. The complete drying out and hardening of the finished product film on the surfaces took place through natural external drying or evaporation. Afterwards parts of the saccharose used as dissolving agent which had crystallised out on the surface were simply washed off with water.

With regard to the quality of the coating product it may also be stated that in its liquid or paintable state it has a somewhat milky quality, but after drying and hardening it forms a thin glass-like, transparent film. In this way a completely waterproof coating is produced which has moreover penetrated sufficiently deeply into the pores of the building material in order reliably to prevent renewed growth of moss. A further advantage is that the glass-like coating produces a clean unspoilt appearance of the mosaic walls of this swimming pool.

In the alternative method wherein the first and second solutions were not mixed, the second solution was applied to the surface first, then dried, following which the first solution was applied over the coating formed by the dried second solution. It is preferable to apply several successive coatings of the second solution, each of which is dried before the application of the succeeding coating, and thereafter apply successively the same number of coatings of the first solution to the earlier applied coatings. Again, each coating of the first solution is dried prior to the application of each succeeding coating.

I claim:

1. A method of producing a product for waterproofing and protecting a surface of solid building material against liquids and chemical and biological corrosion, said method comprising:
a) preparing a first aqueous solution by dissolving calcium oxide in a first quantity of water to which has been added a dissolving agent which increases the quantity of calcium oxide which may be dissolved in said first quantity of water;
b) preparing a second aqueous solution by introducing a quantity of sodium silicate into a second quantity of water; and
c) mixing the first aqueous solution and the second aqueous solution thereby forming an aqueous product containing silica, calcium, and sodium ions, said aqueous product, when dried, being capable of forming a glass-like waterproof surface film on said building material surface.

2. The method according to claim 1 wherein the dissolving agent is saccharose.

3. The method according to claim 1 wherein the dissolving agent is glycerine.

4. The method according to claim 1 wherein said water is demineralised and including degasifying first quantity of said demineralised water prior to the adding of said dissolving agent thereto.

5. The method according to claim 1 wherein said calcium oxide comprises selectively quicklime or calcium hydroxide.

6. The method according to claim 5 wherein said quicklime or calcium hydroxide is added in a quantity selected with reference to the quantity of dissolving agent present in said first quantity of water.

7. The method according to claim 1 wherein said calcium oxide comprises calcium hydroxide.

8. The method according to claim 1 wherein said calcium oxide or calcium hydroxide is dissolved in said first quantity of water at room temperature.

9. The method according to claim 8 wherein said calcium hydroxide is added in a quantity selected with reference to the quantity of dissolving agent present in said first quantity of water.

10. The method according to claim 1 wherein the quantities of calcium oxide and sodium silicate added to the first and second aqueous solutions respectively are in such quantities that the aqueous product contains a ratio of Ca:Na₂ of approximately 0.1:1.0.

11. The method according to claim 1 wherein said sodium silicate is in the form of sodium metasilicate pentahydrate or other form of water soluble sodium silicate.

12. An aqueous product applicable in a wet state to a surface of a solid building material for waterproofing and impregnating said surface against liquids and chemical and biological corrosion, said aqueous product being capable of being dried after its application to said surface, said aqueous product comprising an aqueous solution containing silica, calcium, and sodium ions, said aqueous product, when dried after its application to said surface forming a glass-like film on said surface.

13. The product according to claim 12 wherein said aqueous product contains calcium and sodium in a ratio of Ca:Na₂ of approximately 0.1:1.0.

14. The product according to claim 12 and including the following components by weight %:
52.5 to 56% water;
24 to 33% saccharose;
1.9 to 2.7% calcium oxide; and
8.6 to 21.3% sodium metasilicate pentahydrate.

15. The product according to claim 12 and including the following components by weight %:
55.6 to 68% water;
31 to 36.6% glycerine;
1.1 to 1.31% calcium oxide; and
4.3 to 12.3% sodium metasilicate pentahydrate.

16. A method of waterproofing a surface of solid building material comprising:
a) preparing a first aqueous solution by dissolving calcium oxide in a first quantity of water;
b) preparing a second aqueous solution by introducing a quantity of sodium silicate into a second quantity of water; and
c) coating said surface with said first and second solutions prior to the formation and precipitation of a double silicate.

17. The method according to claim 16 including mixing said first and second solutions together shortly prior to the coating of said surface.

18. The method according to claim 16 including applying said first and second solutions to said surface sequentially commencing with said second solution.

19. The method according to claim 18 including drying the coating formed by said second solution prior to applying said first solution.

20. The method according to claim 16 including applying a plurality of coatings of said second solution to said surface followed by applying a plurality of coatings of said first solution over the coatings of said second solution.

21. The method according to claim 20 including drying each of said coatings prior to applying another of said coatings.

22. The method according to claim 20 wherein the number of coatings of each of said first and second solutions is equal.
